(19) United States
(12) Patent Application Publication
(10) Pub. No.: US 2026/0087638 A1
(43) Pub. Date: Mar. 26, 2026

(54) HOST, SINGLE-CAMERA-BASED TRACKING SYSTEM, AND SINGLE-CAMERA-BASED TRACKING METHOD

(71) Applicant: HTC Corporation, Taoyuan City (TW)

(72) Inventor: Yu-Tzu Wang, Taoyuan City (TW)

(73) Assignee: HTC Corporation, Taoyuan City (TW)

(21) Appl. No.: 18/896,919

(22) Filed: Sep. 26, 2024

(51) Int. Cl. G06T 7/20

(52) U.S. Cl. CPC G06T 7/20; G06T 2207/30196

(57) ABSTRACT

A host is described herein. A processor is configured to access a program code to execute: obtaining image data through a camera of a tracking device, wherein the tracking device is configured to be disposed on a home location; determining that whether the tracking device is at the home location or not based on the image data; in response to the tracking device being not at the home location, performing a device tracking of the tracking device based on the image data; determining a device coordinate of the tracking device based on the device tracking; determining that whether the tracking device is disposed back to the home location or not based on the image data; and in response to the tracking device being disposed back to the home location, determining that the device coordinate of the tracking device being same as a home coordinate of the home location.

### BACKGROUND

### Technical Field

The disclosure relates to a host; particularly, the disclosure relates to a host, a single-camera-based tracking system, and a single-camera-based tracking method.

### Description of Related Art

In order to bring an immersive experience to user, technologies related to extended reality (XR), such as augmented reality (AR), virtual reality (VR), and mixed reality (MR) are constantly being developed. AR technology allows a user to bring virtual elements to the real world. VR technology allows a user to enter a whole new virtual world to experience a different life. MR technology merges the real world and the virtual world. Further, to bring a fully immersive experience to the user, visual content, audio content, or contents of other senses may be provided through one or more devices.

### SUMMARY

The disclosure is direct to a host, a single-camera-based tracking system, and a single-camera-based tracking method, so as to provide an effective and convenient way to calibrate the accumulative error of the single camera.

The embodiments of the disclosure provide a host. The host includes a storage circuit, configured to store a program code; and a processor, coupled to the storage circuit and configured to access the program code to execute: obtaining image data through a camera of a tracking device, wherein the tracking device is configured to be disposed on a home location; determining that whether the tracking device is at the home location or not based on the image data; in response to the tracking device being not at the home location, performing a device tracking of the tracking device based on the image data; determining a device coordinate of the tracking device based on the device tracking; determining that whether the tracking device is disposed back to the home location or not based on the image data; and in response to the tracking device being disposed back to the home location, determining that the device coordinate of the tracking device being same as a home coordinate of the home location.

The embodiments of the disclosure provide a single-camera-based tracking system. The single-camera-based tracking system includes a tracking device, including a camera, wherein the camera is configured to obtain image data; a storage circuit, configured to store a program code; and a processor, coupled to the storage circuit and configured to access the program code to execute: obtaining the image data through the camera of the tracking device, wherein the tracking device is configured to be disposed on a home location; determining that whether the tracking device is at the home location or not based on the image data; in response to the tracking device being not at the home location, performing a device tracking of the tracking device based on the image data; determining a device coordinate of the tracking device based on the device tracking; determining that whether the tracking device is disposed back to the home location or not based on the image data; and in response to the tracking device being disposed back to the home location, determining that the device coordinate of the tracking device being same as a home coordinate of the home location.

The embodiments of the disclosure provide a single-camera-based tracking method. The single-camera-based tracking method includes: obtaining, by a processor, image data through a camera of a tracking device, wherein the tracking device is configured to be disposed on a home location; determining, by the processor, that whether the tracking device is at the home location or not based on the image data; in response to the tracking device being not at the home location, performing, by the processor, a device tracking of the tracking device based on the image data; determining, by the processor, a device coordinate of the tracking device based on the device tracking; determining, by the processor, that whether the tracking device is disposed back to the home location or not based on the image data; and in response to the tracking device being disposed back to the home location, determining, by the processor, that the device coordinate of the tracking device being same as a home coordinate of the home location.

Based on the above, according to the host, the single-camera-based tracking system, and the single-camera-based tracking method, an effective and convenient way to calibrate the accumulative error of the single camera is achieved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic diagram of a host according to an embodiment of the disclosure.

FIG. 1B is a schematic diagram of a single-camera-based tracking system according to an embodiment of the disclosure.

FIG. 2 is a schematic diagram of a single-camera-based tracking scenario according to an embodiment of the disclosure.

FIG. 3 is a schematic diagram of a single-camera-based tracking scenario according to an embodiment of the disclosure.

FIG. 4 is a schematic flowchart of a single-camera-based tracking method according to an embodiment of the disclosure.

FIG. 5 is a schematic flowchart of a single-camera-based tracking method according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to present a smooth experience in the virtual world, multiple devices are often used to track a movement of a user or an object. For example, camera-based tracking, or visual-based tracking, is a crucial technology that enables a user to interact with the virtual environment in a natural and immersive way. Camera-based tracking involves using cameras to track the position and orientation of the user's head, hand, and sometimes even the entire body. In one embodiment, distinctive features like corners, edges, or blobs are extracted from the camera images. Then, these features are tracked across consecutive frames to estimate the camera's movement and orientation. In addition, SLAM (Simultaneous Localization and Mapping) algorithms are used to create a 3D map of the environment while simultaneously estimating the camera's pose within that map.

It is noted that, in order to perform the camera-based tracking accurately, a depth camera or multiple cameras for sensing the depth information may be needed. This is because that 3D information may be needed for correcting “drift” integrated from time to time. Drift in a camera-based tracking system is a common phenomenon caused by various factors. Feature tracking errors, which may arise from changes in lighting conditions, occlusions, motion blur, and repetitive textures, may lead to inaccurate pose estimation. Additionally, the lack of depth information may make it challenging to accurately estimate the 3D pose of objects. Initialization errors, such as incorrect camera calibration or initial pose estimation, may also contribute to an accumulative error, which is the “drift”, over time.

In other words, a single camera, such as a monocular camera, which capture 2D images, are susceptible to drift caused by factors such as feature tracking failures, occlusions, and the lack of depth information. Without an accurate estimate of depth, it is challenging for utilizing one single camera to determine the scale and absolute position of the tracked object. Therefore, it is the pursuit of people skilled in the art to provide an effective and convenient way to calibrate the accumulative error of the single camera.

In this disclosure, a home location of a device is preset and used to calibrate a coordinate of the device. A calibration of the coordinate of the device may be performed by putting the device back to the home location. Therefore, an effective and convenient way to calibrate the accumulative error of the single camera is achieved.

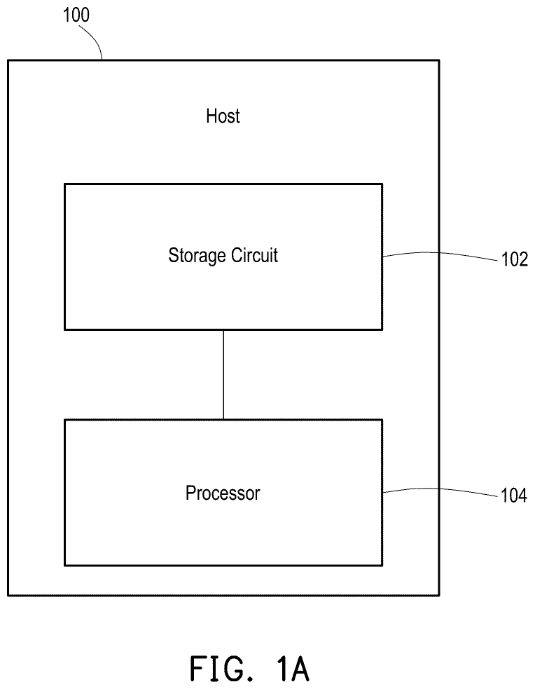

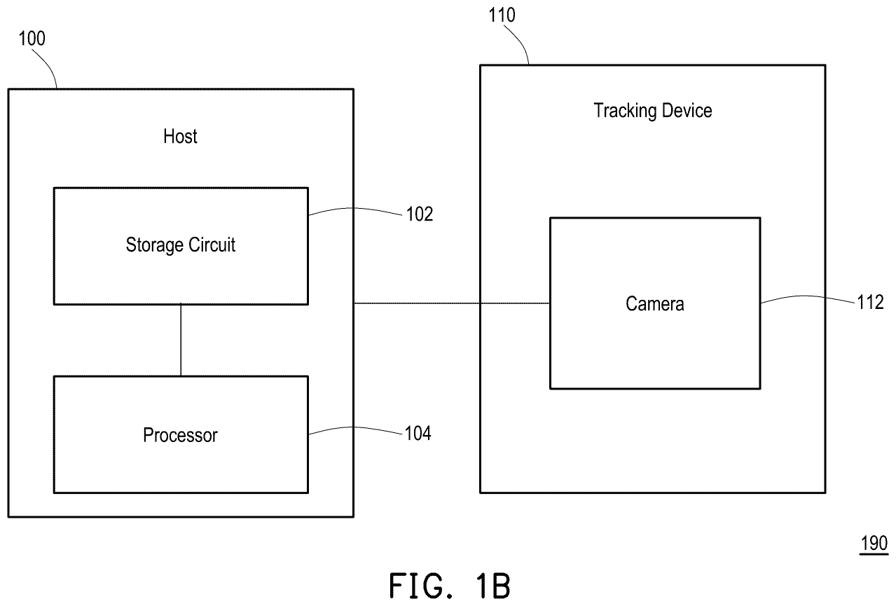

FIG. 1A is a schematic diagram of a host according to an embodiment of the disclosure. In various embodiments, a host 100 may be any smart device and/or computer device. In some embodiments, the host 100 may be any electronic device capable of providing reality services (e.g., AR/VR/MR services, or the like). In some embodiments, the host 100 may be implemented as an XR device, such as a pair of AR/VR glasses and/or a head-mounted display (HMD) device. In some embodiments, the host 100 may be a self-tracking device which may include a plurality of cameras and may be able to track itself. In some embodiments, the host 100 may be a computer and/or a server, and the host 100 may provide the computed results (e.g., AR/VR/MR contents) to other external display device(s) (e.g., the HMD), such that the external display device(s) can show the computed results to the user. However, this disclosure is not limited thereto.

In FIG. 1A, the host 100 includes a storage circuit 102 and a processor 104. The storage circuit 102 is one or a combination of a stationary or mobile random access memory (RAM), read-only memory (ROM), flash memory, hard disk, or any other similar device, and which records a plurality of modules and/or a program code that can be executed by the processor 104.

The processor 104 may be coupled with the storage circuit 102, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In the embodiments of the disclosure, the processor 104 may access the modules and/or the program code stored in the storage circuit 102 to implement a single-camera-based tracking method provided in the disclosure, which would be further discussed in the following.

FIG. 1B is a schematic diagram of a single-camera-based tracking system according to an embodiment of the disclosure. In FIG. 1B, a single-camera-based system 190 may include the host 100 and a tracking device 110. The tracking device 110 may include a camera 112. Details of the host 100 may be referred to the description of FIG. 1A, while the details are not redundantly described seriatim herein.

In the embodiments of the disclosure, the camera 112 may be configured to capture environmental images of the environment where the tracking device 110 locates. The environmental images may be panoramas and/or cubemaps, but the disclosure is not limited thereto. In some embodiments, the camera 112 may be, for example, a complementary metal oxide semiconductor (CMOS) camera, a charge coupled device (CCD) camera, or other similar device. However, this disclosure is not limited thereto.

In some embodiments, the host 100 may further include a communication circuit and the communication circuit may include, for example, a wired network module, a wireless network module, a Bluetooth module, an infrared module, a radio frequency identification (RFID) module, a Zigbee network module, or a near field communication (NFC) network module, but the disclosure is not limited thereto. That is, the host 100 may communicate with external device(s) (such as the camera 112, a tracker, a display . . . etc.) through either wired communication or wireless communication.

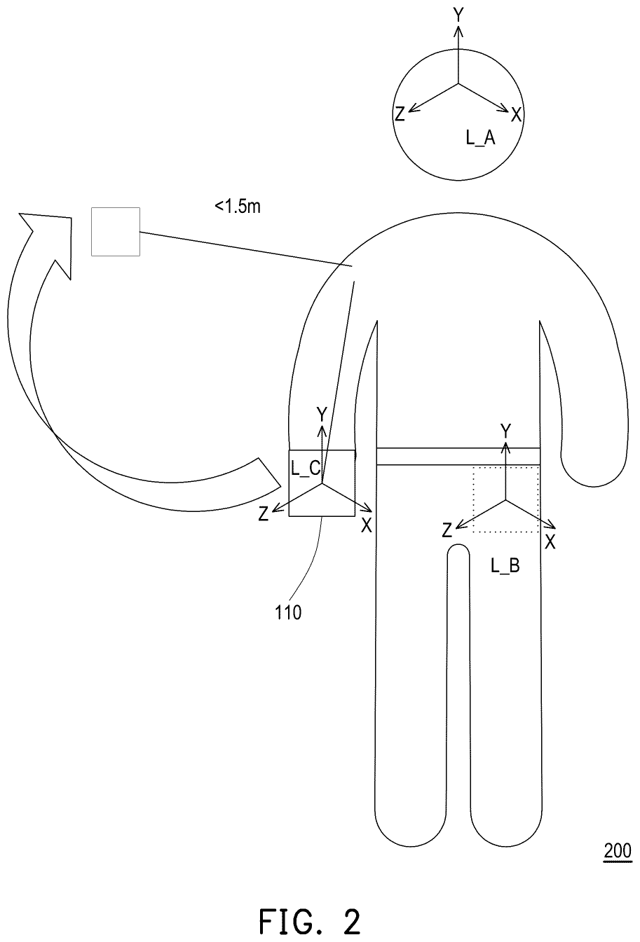

FIG. 2 is a schematic diagram of a single-camera-based tracking scenario according to an embodiment of the disclosure. In FIG. 2, a single-camera-based tracking scenario 200 include a user, the tracking device 110, and a plurality of locations L_A˜L_C.

In one embodiment, the user may wear an HMD device for experiencing an XR application. For example, the HMD device may be disposed on a head of the user and the place where the HMD disposed may be referred to as the location L_A (also known as a “head location”). In some embodiments, the location L_A may be referred to, instead of a head location, a location of a self-tracking device which may include a plurality of cameras and may be mounted to different part of the body according to design needs. On the other hand, the tracking device 110 may be configured to provide various functions to improve the immersive experience of the XR application. Further, the tracking device 110 may be originally disposed on a body part (e.g., the waist) the user, so that the user may easily pick up the tracking device 110 to hold in hand. The place where the tracking device 110 is originally disposed may be referred to as the location L_B (also known as a “home location”). Furthermore, when the user is holding the tracking device 110, a present location of the tracking device 110 may be referred to as the location L_C.

It is noted that, when the user stands still in one place, a farthest distance that the tracking device 110 may go (e.g., moving away from the user) may be less than 1.5 meters due to the length of the arm of the user. That is, the farther distance may be determined based on the length of the arm or the height of the user. However, this disclosure is not limited thereto. Under such circumstance, even if the drift accumulates over time, the error caused by the drift may only on the order of millimeters. That is, the drift may be neglectable.

On the other hand, as the user moves around in the environment, the error caused by the drift may increase due to the increased distance of movement. In order to mitigate the influence of the error caused by the drift, the user may put the tracking device 110 back to the location L_B for calibration. For example, when the tracking device 110 is put back to the location L_B, a device coordinate of the tracking device 110 may be determined as a home coordinate of the location L_B.

That is, when the tracking device 110 is moving around in the environment, the tracking device 110 may be configured to track itself by performing a device tracking (i.e., self-tracking) based on image data of the camera 112. In other words, the device coordinate of the tracking device 110 may be determined based on the device tracking. Then, each time when the user put the tracking device 110 back to the home location, the device coordinate of the tracking 110 may be calibrated and determined being same as the home coordinate of the home location (i.e., location L_B). That is to say, the home location may be used as a reference for calibrating the drift of the device coordinate of the tracking device 110 or reset the device coordinate of the tracking device 110.

In other words, the processor 104 may be configured to obtain image data through the camera 112 of the tracking device 110. The tracking device 110 may be configured to disposed on the home location. Further, the processor 104 may be configured to determine that whether the tracking device 110 (i.e., location L_C) is at the home location or not based on the image data. Then, in response to the tracking device 110 being not at the home location (i.e., leaving the home location), the processor 104 may be configured to perform the device tracking of the tracking device 110 based on the image data. Furthermore, the processor 104 may be configured to determine the device coordinate of the tracking device 110 based on the device tracking. Moreover, the processor 104 may be configured to determine that whether the tracking device 110 is disposed back to the home location. Then, in response to the tracking device 110 being disposed back to the home location based on the image data, the processor 104 may be configured to determine that the device coordinate of the tracking device 110 being same as the home coordinate of the home location.

In this manner, even if the device tracking is performed based on only one single camera, the influence of the error caused by the drift may be decreased. Further, compared with utilized the depth camera or multiple cameras for the device tracking, a cost and a computational complexity of the device tracking may be reduced. Therefore, an effective and convenient way to calibrate the accumulative error of the single camera is achieved.

In one embodiment, when the tracking device 110 stays at the home location, the device coordinate of the tracking device 110 may keep being same as the home coordinate of the home location. That is, in response to the tracking device 110 being at the home location, the processor 104 may be configured to lock the device coordinate to the home coordinate.

In one embodiment, a departure from and a return to the home location of the tracking device 110 may be determined based on the device tracking. For example, the device tracking may be configured to detect a distance between the tracking device 110 and the home location. That is, the processor 104 may be configured to determine that whether a distance between the tracking device 110 and the home location is greater than a threshold distance or not based on the device tracking. The threshold distance may be predetermined according to design needs or user's preference. Then, in response to the distance being greater than the threshold distance, the processor 104 may be configured to determine that the tracking device 110 being not at the home location. On the other hand, in response to the distance being not greater than the threshold distance, the processor 104 may be configured to determine that the tracking device 110 being disposed back to the home location. In this manner, the departure from and the return to the home location of the tracking device 110 may be determined easily.

It is noted that, due to the accumulative error caused by the drift over time, the accuracy of the device tracking may decrease over time. Therefore, an alternative or a complementary mechanism for detecting the departure from and the return to the home location of the tracking device 110.

In one embodiment, a departure from and a return to the home location of the tracking device 110 may be determined based on a change of the image data. It is worth mentioned that, when the tracking device 110 stays at the home location, the camera 112 of the tracking device 110 may capture similar or same images. On the other hand, when the tracking device 110 is taking away from the home location, the camera 112 of the tracking device 110 may start capturing different images. That is, a change of the image data may occur. The change of the image data may be a change in an image characteristic of the image data and may refer to a change in brightness, contrast, color, sharpness, noise levels, etc. In other words, the processor 104 may be configured to determine that whether a change of the image data is greater than a threshold value or not. Then, in response to the change being greater than the threshold value, the processor 104 may be configured to determine that the tracking device 110 being not at the home location. On the other hand, in response to the change being not greater than the threshold value, the processor 104 may be configured to determine that the tracking device 110 being disposed back to the home location. In this manner, the departure from and the return to the home location of the tracking device 110 may be determined accurately.

In one embodiment, the tracking device 110 may be disposed in an accommodation area at the home location. The accommodation area may be a bag, a box, a holster, or other similar things. That is, the when the tracking device 110 stays at the home location, the camera 112 of the tracking device 110 may be covered by the accommodation area (e.g., by a lid). Therefore, a departure from and a return to the home location of the tracking device 110 may be determined by detecting the camera 112 being covered or not. In one embodiment, the camera 112 being cover or not may be determined based on a luminance value or a brightness or the image data, but is not limited thereto. In other words, the processor 104 may be configured to determine that whether the camera 112 is covered or not based on the image data. Then, in response to the camera 112 being not covered, the processor 104 may be configured to determine that the tracking device 110 being not at the home location. On the other hand, in response to the camera 112 being covered, the processor 104 may be configured to determine that the tracking device 110 being disposed back to the home location. In this manner, the departure from and the return to the home location of the tracking device 110 may be determined accurately.

In one embodiment, a Hall effect sensor may be disposed on the home location. The Hall effect sensor is an electronic device that can detect magnetic fields. When an object moves closes to or away from the Hall effect sensor, it may produce a change in voltage. By measuring this voltage change, a proximity or distance of the object may be determined. Therefore, a departure from and a return to the home location of the tracking device 110 may be determined based on a Hall effect sensor. In other words, the processor 104 may be configured to obtain a voltage value of a Hall effect sensor and the Hall effect sensor is disposed on the home location. Then, in response to the voltage value being not greater than a threshold voltage, the processor 104 may be configured to determine that the tracking device 110 being not at the home location. On the other hand, in response to the voltage value being greater than the threshold voltage, the processor 104 may be configured to determine that the tracking device 110 being disposed back to the home location. In this manner, the departure from and the return to the home location of the tracking device 110 may be determined accurately.

It is worth mentioned that, when the tracking device 110 is brought close to but not back to the home location, under certain circumstances, the detection mechanism sometimes may determine that the tracking device 110 is disposed back to the home location. Therefore, in order to distinguish these two conditions, an addition requirement may be utilized to determine a state of the tracking device 110 accurately. For example, only when the tracking device 110 stays at the home location over a threshold time, the tracking 110 will be determined as be disposed back to the home location. That is, the processor 104 may be configured to determine a staying time of the tracking device 110 at the home location. Then, in response to the staying time being not greater than a threshold time, the processor 104 may be configured to determine that the tracking device 110 being not at the home location. On the other hand, in response to the staying time being greater than the threshold time, the processor 104 may be configured to determine that the tracking device 110 being disposed back to the home location. In this manner, the departure from and the return to the home location of the tracking device 110 may be determined accurately.

In one embodiment, the HMD device may include a plurality of cameras and/or trackers to establish an environment map of the environment around the user based on data of the plurality of cameras and/or trackers by utilizing a SLAM algorithm. The environment map may have a head coordinate system and an origin of the head coordinate system may be the head location (i.e., location L_A). Further, the tracking device 110 may also utilized the environment map to determine the device coordinate of the tracking device 110. That is, the tracking device 110 may also use the head location as the origin of a coordinate system. It other words, a device coordinate system may align with the head coordinate system. Therefore, when the tracking device 110 is disposed on the home location (i.e., location L_B), the device coordinate of the tracking device 110 may be determined based on the head coordinate.

For example, the relationship between the head location and the home location may be considered as a rigid body relationship. That is, a body of the user may be considered as a rigid body and a distance between the head location and the home location may be considered as a fixed distance. In other words, the home coordinate of the home location may be determined based on the head coordinate and the fixed distance. That is to say, in response to the tracking device 110 being disposed back to the home location, the processor 104 may be configured to align a device coordinate system of the tracking device 110 with a head coordinate system of a HMD device.

It is noted that, since the head coordinate is determined based on data of the plurality of cameras and/or trackers, the drift of the head coordinate may be already corrected. That is to say, the head location may be used as a reference for calibrating the drift of the home location. Further, the home location may be used as a reference for calibrating the drift of the device coordinate of the tracking device 110. In this manner, an effective and convenient way to calibrate the accumulative error of the single camera is achieved.

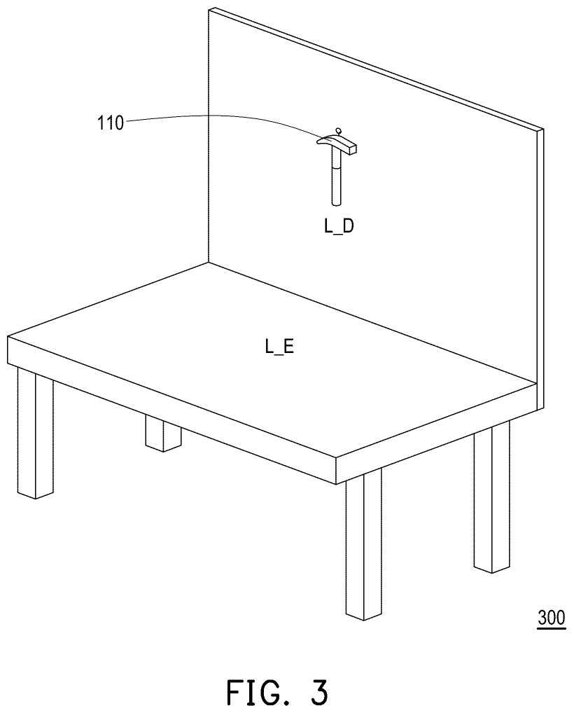

FIG. 3 is a schematic diagram of a single-camera-based tracking scenario according to an embodiment of the disclosure. In FIG. 3, a single-camera-based tracking scenario 300 may include a workbench, the tracking device 110, a location L_D and a location L_E.

In one embodiment, the tracking device 110 may be embedded in or disposed on a tool, such as a hammer. The tool is originally disposed on a wall of the workbench and the place where the tool being disposed may be also referred to as the location L_D (also known as the home location). On the other hand, when the user wants to used the tool, the user may put the tool on a desktop of the workbench and the place where the tool being disposed may be also referred to as the location L_E (also known as the work location).

Reference is made to FIG. 2 and FIG. 3 together. That is, the tracking device 110 may be able to be utilized not only in a moving condition (e.g., holding by a moving person), but also in a still condition (e.g., putting on the workbench). In other words, the home location may be disposed on a body part of a user. Alternatively, the home location may be disposed on a workbench. However, this disclosure is not limited thereto.

It is noted that, in a training or a competition, a user may need to find a certain job by operating a plurality of tools in sequence. In one embodiment, the training or the competition may be evaluated by the time it takes the user to complete the certain job. Assuming the user is operating the plurality of tools in the right sequence, a time difference between a first time that the user takes the first tool and a second time that the user puts the last tool back may be utilized for the evaluation. That is, a first tool and a second tool may be disposed on a first home location and a second home location respectively. Further, a first tracking device is originally disposed on the first tool and a second tracking device is originally disposed on the second tool. The first tracking device and the second tracking device may be same as the tracking device 110. Furthermore, the processor 104 may be configured to obtain a first time that a user takes the first tool away from the first home location and obtain a second time that the user puts the second tool back to the second home location. Moreover, the processor 104 may be configured to evaluate a score based on a time difference between the first time and the second time. For example, as the time difference is shorter, the higher score the evaluation is. In this manner, the training or the competition may be evaluated accurately, thereby improving the user experience.

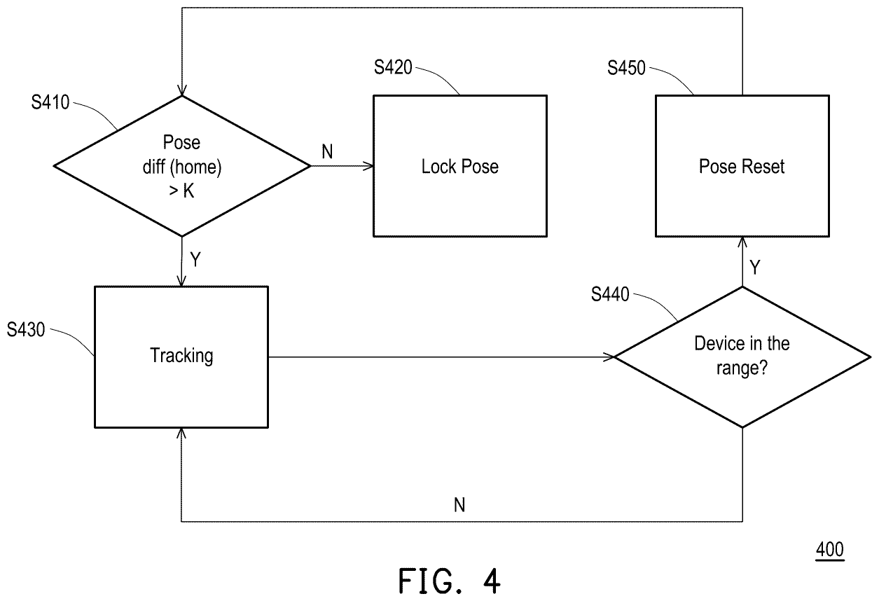

FIG. 4 is a schematic flowchart of a single-camera-based tracking method according to an embodiment of the disclosure. In FIG. 4, a single-camera-based tracking method 400 may include steps S410 to S450.

In the step S410, the processor 104 may be configured to obtain a device pose of the tracking device 110 and determine whether a pose difference of the device pose is greater than the threshold difference (e.g., K as shown in FIG. 4). In the step S420, when the pose difference is not greater than the threshold difference, the tracking device 110 may be determined being stayed at the home location. That is, the device coordinate of the tracking device 110 may be locked to the home coordinate of the home location. On the other hand, in the step S430, when the pose difference is greater than the threshold, the tracking device 110 may be determined being taken away from the home location. That is, the device tracking may be performed and the device coordinate of the tracking device 110 may be determined based on the device tracking.

In the step S440, the processor 104 may be configured to determined that whether the tracking device 110 is in a range around the home location. If not, the device coordinate of the tracking device 110 may be still determined based on the device tracking. If yes, in the step S450, the device coordinate of the tracking device 110 may be calibrated and determined being same as the home coordinate of the home location.

In this manner, an effective and convenient way to calibrate the accumulative error of the single camera is achieved.

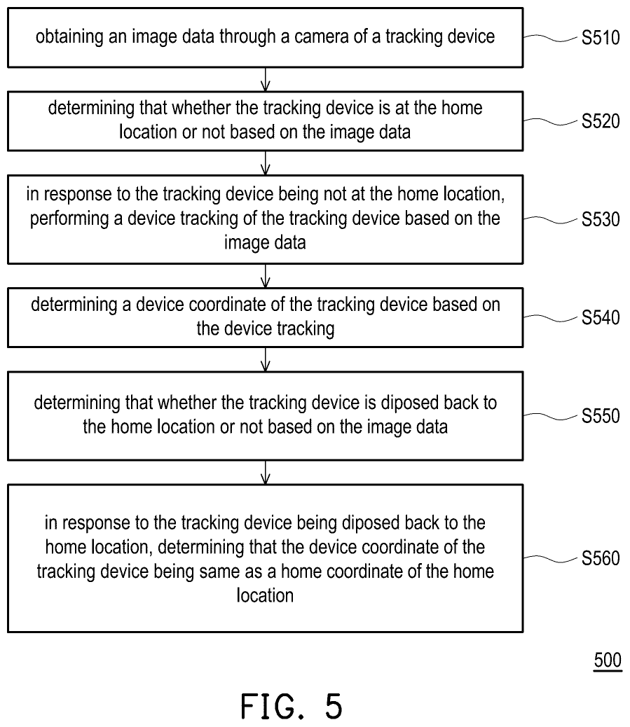

FIG. 5 is a schematic flowchart of a single-camera-based tracking method according to an embodiment of the disclosure. In FIG. 5, a single-camera-based tracking method 500 may include steps S510 to S560.

In the step S510, the processor 104 may be configured to obtain image data through the camera 112 of the tracking device 110. The tracking device 110 is configured to be disposed on a home location. In the step S520, the processor 104 may be configured to determine that whether the tracking device 110 is at the home location or not based on the image data. In the step S530, in response to the tracking device 110 being not at the home location, the processor 104 may be configured to perform a device tracking of the tracking device 110 based on the image data. In the step S540, the processor 104 may be configured to det determine a device coordinate of the tracking device 110 based on the device tracking. In the step S550, the processor 104 may be configured to determine that whether the tracking device 110 is disposed back to the home location or not based on the image data. In the step S560, in response to the tracking device 110 being disposed back to the home location, the processor 104 may be configured to determine that the device coordinate of the tracking device 110 being same as a home coordinate of the home location.

In addition, the implementation details of the single-camera-based tracking method 500 may be referred to the descriptions of FIG. 1 to FIG. 4 to obtain sufficient teachings, suggestions, and implementation embodiments, while the details are not redundantly described seriatim herein.

In this manner, an effective and convenient way to calibrate the accumulative error of the single camera is achieved.

In summary, according to the host, the single-camera-based tracking system, and the single-camera-based tracking method, even if the device tracking is performed based on only one single camera, the influence of the error (such as scale issue) caused by the drift may be decreased. Further, compared with utilized the depth camera or multiple cameras for the device tracking, a cost and a computational complexity of the device tracking may be reduced. Therefore, an effective and convenient way to calibrate the accumulative error of the single camera is achieved.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A host, comprising:
a storage circuit, configured to store a program code; and
a processor, coupled to the storage circuit and configured to access the program code to execute:
obtaining image data through a camera of a tracking device, wherein the tracking device is configured to be disposed on a home location;
determining that whether the tracking device is at the home location or not based on the image data;
in response to the tracking device being not at the home location, performing a device tracking of the tracking device based on the image data;
determining a device coordinate of the tracking device based on the device tracking;
determining that whether the tracking device is disposed back to the home location or not based on the image data; and
in response to the tracking device being disposed back to the home location, determining that the device coordinate of the tracking device being same as a home coordinate of the home location.

2. The host according to claim 1, wherein the processor is further configured to access the program code to execute:
in response to the tracking device being at the home location, lock the device coordinate to the home coordinate.

3. The host according to claim 1, wherein the processor is further configured to access the program code to execute:
determining that whether a distance between the tracking device and the home location is greater than a threshold distance or not based on the device tracking;
in response to the distance being greater than the threshold distance, determining that the tracking device being not at the home location; and
in response to the distance being not greater than the threshold distance, determining that the tracking device being disposed back to the home location.

4. The host according to claim 1, wherein the processor is further configured to access the program code to execute:
determining that whether a change of the image data is greater than a threshold value or not;
in response to the change being greater than the threshold value, determining that the tracking device being not at the home location; and
in response to the change being not greater than the threshold value, determining that the tracking device being disposed back to the home location.

5. The host according to claim 1, wherein the processor is further configured to access the program code to execute:
determining that whether the camera is covered or not;
in response to the camera being not covered, determining that the tracking device being not at the home location; and
in response to the camera being covered, determining that the tracking device being disposed back to the home location.

6. The host according to claim 1, wherein the processor is further configured to access the program code to execute:
obtaining a voltage value of a Hall effect sensor, wherein the Hall effect sensor is disposed on the home location;
in response to the voltage value being not greater than a threshold voltage, determining that the tracking device being not at the home location; and
in response to the voltage value being greater than the threshold voltage, determining that the tracking device being disposed back to the home location.

7. The host according to claim 1, wherein the processor is further configured to access the program code to execute:
determine a staying time of the tracking device at the home location;
in response to the staying time being not greater than a threshold time, determining that the tracking device being not at the home location; and
in response to the staying time being greater than the threshold time, determining that the tracking device being disposed back to the home location.

8. The host according to claim 1, wherein the processor is further configured to access the program code to execute:
in response to the tracking device being disposed back to the home location, aligning a device coordinate system of the tracking device with a head coordinate system of a head-mounted display device, wherein the head-mounted display device is adapted to be disposed on a head of a user.

9. The host according to claim 1, wherein a home location is disposed on a body part of a user.

10. The host according to claim 1, wherein a home location is disposed on a workbench.

11. The host according to claim 1, wherein the processor is further configured to access the program code to execute:
obtaining a first time that a user takes a first tool away from a first home location, wherein the first tool is originally disposed on the first home location;
obtaining a second time that the user puts a second tool back to a second home location, wherein the second tool is originally disposed on the second home location; and
evaluating a score based on a time difference between the first time and the second time.

12. A single-camera-based tracking system, comprising:
a tracking device, comprising a camera, wherein the camera is configured to obtain image data;
a storage circuit, configured to store a program code; and
a processor, coupled to the storage circuit and configured to access the program code to execute:
obtaining the image data through the camera of the tracking device, wherein the tracking device is configured to be disposed on a home location;
determining that whether the tracking device is at the home location or not based on the image data;
in response to the tracking device being not at the home location, performing a device tracking of the tracking device based on the image data;
determining a device coordinate of the tracking device based on the device tracking;
determining that whether the tracking device is disposed back to the home location or not based on the image data; and
in response to the tracking device being disposed back to the home location, determining that the device coordinate of the tracking device being same as a home coordinate of the home location.

13. The single-camera-based tracking system according to claim 12, wherein the processor is further configured to access the program code to execute:
in response to the tracking device being at the home location, lock the device coordinate to the home coordinate.

14. The single-camera-based tracking system according to claim 12, wherein the processor is further configured to access the program code to execute:
determining that whether a distance between the tracking device and the home location is greater than a threshold distance or not based on the device tracking;
in response to the distance being greater than the threshold distance, determining that the tracking device being not at the home location; and
in response to the distance being not greater than the threshold distance, determining that the tracking device being disposed back to the home location.

15. The single-camera-based tracking system according to claim 12, wherein the processor is further configured to access the program code to execute:
determining that whether a change of the image data is greater than a threshold value or not;
in response to the change being greater than the threshold value, determining that the tracking device being not at the home location; and
in response to the change being not greater than the threshold value, determining that the tracking device being disposed back to the home location.

16. The single-camera-based tracking system according to claim 12, wherein the processor is further configured to access the program code to execute:
determining that whether the camera is covered or not;
in response to the camera being not covered, determining that the tracking device being not at the home location; and
in response to the camera being covered, determining that the tracking device being disposed back to the home location.

17. The single-camera-based tracking system according to claim 12, wherein the processor is further configured to access the program code to execute:
obtaining a voltage value of a Hall effect sensor, wherein the Hall effect sensor is disposed on the home location;
in response to the voltage value being not greater than a threshold voltage, determining that the tracking device being not at the home location; and
in response to the voltage value being greater than the threshold voltage, determining that the tracking device being disposed back to the home location.

18. The single-camera-based tracking system according to claim 12, wherein the processor is further configured to access the program code to execute:
determine a staying time of the tracking device at the home location;
in response to the staying time being not greater than a threshold time, determining that the tracking device being not at the home location; and
in response to the staying time being greater than the threshold time, determining that the tracking device being disposed back to the home location.

19. The single-camera-based tracking system according to claim 12, wherein the processor is further configured to access the program code to execute:
in response to the tracking device being disposed back to the home location, aligning a device coordinate system of the tracking device with a head coordinate system of a head-mounted display device, wherein the head-mounted display device is adapted to be disposed on a head of a user.

20. A single-camera-based tracking method, comprising:
obtaining, by a processor, image data through a camera of a tracking device, wherein the tracking device is configured to be disposed on a home location;
determining, by the processor, that whether the tracking device is at the home location or not based on the image data;
in response to the tracking device being not at the home location, performing, by the processor, a device tracking of the tracking device based on the image data;
determining, by the processor, a device coordinate of the tracking device based on the device tracking;
determining, by the processor, that whether the tracking device is disposed back to the home location or not based on the image data; and
in response to the tracking device being disposed back to the home location, determining, by the processor, that the device coordinate of the tracking device being same as a home coordinate of the home location.
